(19) United States
(12) Patent Application Publication
(10) Pub. No.: US 2010/0018370 A1
(43) Pub. Date: Jan. 28, 2010

(54) METHOD AND APPARATUS FOR MANUFACTURING WOUND DRESSING FOR NEGATIVE PRESSURE WOUND THERAPY

(76) Inventors: David Tumey, Germantown, MD (US); Richard C. Vogel, Potomac, MD (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/360,152

(22) Filed: Jan. 27, 2009

Related U.S. Application Data
(60) Provisional application No. 61/023,998, filed on Jan. 28, 2008.

(51) Int. Cl. B26D 7/18

(52) U.S. Cl. 83/100

(57) ABSTRACT

An apparatus includes a cutting tool configured to cut a wound dressing and a tube having a distal end portion and a proximal end portion. The proximal end portion of the tube is operatively coupled to a suction source. The distal end portion of the tube is configured to be positioned relative to the cutting tool such that particulate debris is received in the distal end portion of the tube when the cutting tool cuts the wound dressing and the suction source is operating.

### CROSS REFERENCES TO RELATED CASES

This application claims priority to and the benefit of U.S. Provisional Patent Application Ser. No. 61/023,998, filed Jan. 28, 2008, which is incorporated herein by reference in its entirety.

This application is related to U.S. patent application Ser. No. 11/350,089, filed Feb. 9, 2006, which is a continuation-in-part of U.S. patent application Ser. No. 11/237,880, filed Sep. 29, 2005, which is a continuation of U.S. patent application Ser. No. 11/198,148, filed Aug. 8, 2005, entitled “Wound Irrigation Device,” each of which is incorporated herein by reference in its entirety.

### BACKGROUND

The invention generally relates to dressings for use in healing wounds through Negative Pressure Wound Therapy (NPWT) applications.

In NPWT, a suction source is connected to a semi-occluded or occluded wound dressing. Various porous dressings having gauze, felts, foams, beads and/or fibers can be used in conjunction with an occlusive semi-permeable cover and a controlled suction source. NPWT is also known as vacuum drainage or closed-suction drainage. In addition to using negative pressure wound therapy, many devices employ concomitant wound irrigation.

NPWT dressings are typically manufactured and sold in a rectangular or oval shape. In the manufacturing process of such NPWT dressings, a larger piece of material (a “bun”) is cut into smaller dressing components using a myriad techniques such as hot-wires, wire saws or die cutting (knife). During the process of cutting the larger bun into the smaller dressing components, small (macroscopic and microscopic) pieces of material become trapped in the open pores of the cut surfaces. This particulate debris can contaminate the woundsite if it is not removed prior to insertion of the dressing in the wound. This unwanted debris is analogous to the “sawdust” produced whenever wood is cut and should be ameliorated prior to the dressing's packaging and sterilization steps.

Compressed air has been used to blow the debris off of and away from the dressing both during and after cutting to remove the small pieces of material from the dressing. With an open-cell foam dressing constructed of, for example, a reticulated polyurethane, however, compressed air can force small particles into cell pockets where they become trapped until the foam dressing is applied to the wound. Contamination of the wound can result if the particles contact and enter the wound.

In another known method, the dressing is washed after the cutting process to remove small particles from the dressing. The cut dressing pieces are washed and dried in machines (like clothes washers). Washing the dressing, however, normally increases the amount of pyrogens present in the dressing. Pyrogens are non-bioactive substances, typically remnants and detritus of dead organisms that can cause a fever when exposed to a wound.

Thus, a need exists for a new method of manufacturing dressings that effectively removes particulate debris from the dressing without increasing the amount of pyrogens present in the dressing.

### SUMMARY

An apparatus includes a cutting tool configured to cut a wound dressing and a tube having a distal end portion and a proximal end portion. The proximal end portion of the tube is operatively coupled to a suction source. The distal end portion of the tube is configured to be positioned relative to the cutting tool such that particulate debris is received in the distal end portion of the tube when the cutting tool cuts the wound dressing and the suction source is operating.

### BRIEF DESCRIPTION OF THE DRAWINGS

FIG. 1 shows a system block diagram of a Negative Pressure Wound Therapy (NPWT) system with irrigation, according to an embodiment.

FIG. 2 shows a perspective view of a manufacturing system for cutting a square undercut channel in a porous dressing, according to an embodiment.

FIG. 3 shows a front view of a manufacturing system cutting a square undercut channel in a porous dressing, according to an embodiment.

FIG. 4 is a front view of a dressing with a square-shaped undercut channel, according to an embodiment.

FIG. 5 shows a perspective view of a manufacturing system for making horizontal cuts in a porous dressing, according to an embodiment.

FIG. 6 shows a front view of a dressing cut according to an embodiment.

FIGS. 7 and 8 are front views of a dressing cut according to an embodiment, in different stages of the manufacturing process.

FIG. 9 shows a perspective view of a manufacturing system for making vertical cuts in a porous dressing, according to an embodiment.

FIG. 10 is a top view of a manufacturing system for making cuts in a porous dressing having a suction manifold attached to the cutting head, according to an embodiment.

FIG. 11 is a perspective view of a manufacturing system for making cuts in a porous dressing having a suction manifold attached to the cutting head, according to an embodiment.

FIG. 12 is a perspective view of a manufacturing system for making cuts in a porous dressing having a suction manifold attached to the cutting head, according to an embodiment.

FIG. 13 shows a front view of a suction manifold with bristles attached, according to an embodiment.

### DETAILED DESCRIPTION

As used herein, the terms proximal portion or proximal end refer to the portion or end, respectively, of a device that is closest to a medical practitioner (e.g., a physician) when performing a medical procedure, and the terms distal portion or distal end refer to the portion or end, respectively, of the device that is furthest from the physician during a medical procedure. For example, a distal end or portion of a suction/irrigation tube as described herein refers to the end or portion of the tube that is connected to the wound dressing. The proximal end or portion is the end or portion of the tube that is connected to a suction source or an irrigation source.

Various embodiments generally relate to wound dressings used in Negative Pressure Wound Therapy (NPWT). According to an embodiment, undercut channels in a wound dressing are used to moveably secure suction/irrigation tubing to the dressing. Undercut channels are channels cut into the dressing configured to receive tubing. The channels can be any size or shape. The tubing can be held in the undercut channels by friction and may be readily repositioned if necessary. In some embodiments, the undercut channels can be similar to the undercut channels shown and described in U.S. patent application Ser. No. 12/357,733, filed Jan. 22, 2009 entitled “Wound Dressing Having Undercut Channels for Negative Pressure Wound Therapy” which is incorporated herein by reference in its entirety.

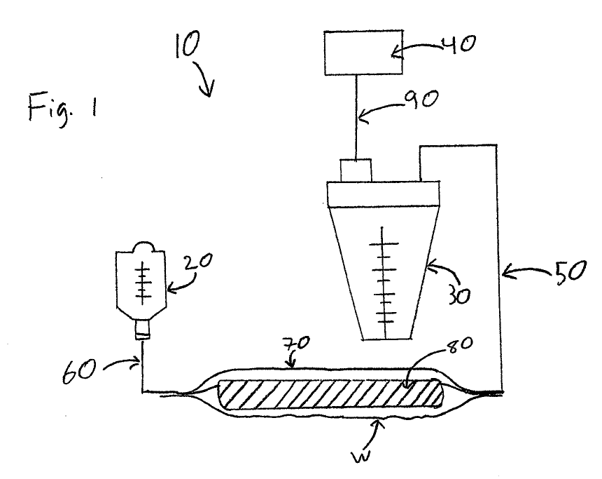

FIG. 1 shows a system block diagram of a NPWT system with wound irrigation, according to an embodiment. The NPWT system 10 has a wound dressing 80, which is shown placed in a wound W. The distal end portions of suction tube 50 and irrigation tube 60 are connected to the wound dressing 80 by, for example, an undercut channel or other suitable means. A covering 70, such as a semi-permeable occlusive sheet or drape, covers the wound dressing 80. The covering 70, for example, can be made of polyurethane film such as that available under the trademark Tegaderm™. The covering 70 is sealed to the skin surrounding the wound by, for example, an adhesive. The proximal end portion of the suction tube 50 is connected to a fluid collection canister 30. The fluid collection canister 30 is connected to a suction source 40 by tubing 90. The proximal end portion of the irrigation tube 60 is connected to a reservoir 20 that contains a solution, such as, by way of example, an aqueous topical antibiotic solution, isotonic saline, Dakin's solution, or a Sulfamide Acetate solution, for use in providing therapy to the wound W.

When the suction source 40 is turned on, a negative pressure is produced at the wound W and fluid from the wound dressing 80 travels through the suction tube 50 and is collected in the fluid collection canister 30. This fluid can include, for example, a mixture of the solution and exudate from the wound. The negative pressure at the wound dressing 80 and/or gravity can cause the solution contained in the reservoir 20 to travel through the irrigation tube 60 and into the wound dressing 80.

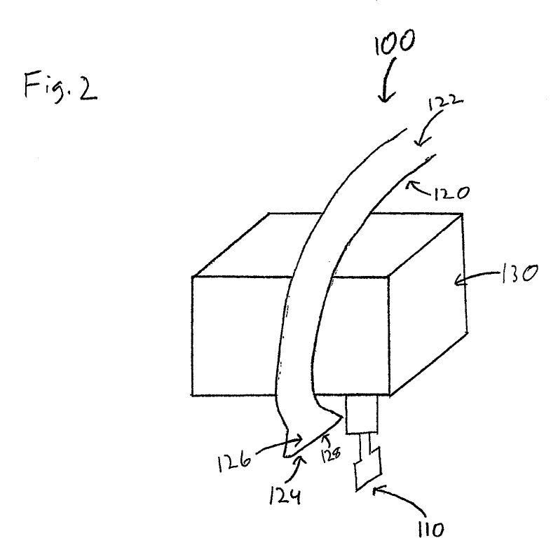

FIG. 2 shows a perspective view of a system for manufacturing porous dressings according to an embodiment. Manufacturing system 100 includes a base 130, a hot-wire cutting head 110 and a suction tube 120. The hot-wire cutting head 110 is coupled to a lower surface of the base 130. The suction tube 120 is coupled to the base 130 such that the position of the suction tube 120 relative to the base 130 is substantially maintained during use.

The hot-wire cutting head 110 is shaped to cut an undercut channel having a square cross section in the top of a dressing. The dressing, for example, can be manufactured from polyurethane foam, polyvinyl alcohol foam, felt or other suitable material. Although a hot-wire cutting tool 110 is used, other suitable cutting devices such as wire saws or knives, may be used.

A suction tube 120 has a first end portion 122 and a second end portion 124. The first end portion 122 of the suction tube 120 is configured to be connected to a suction source (not shown in FIG. 2). The suction source can have a high flow rate similar to that achieved with an industrial shop VAC. The second end portion 124 of the suction tube 120 includes a suction manifold 126. The suction manifold 126 defines at least one opening 128 configured to receive small particulate debris that results from the cutting process when suction is applied to the first end portion of the suction tube 122. The base 130 can be connected to, for example, a fixed frame or a computer controlled cutting machine that can be used to control the manufacturing process. In addition to removing unwanted particulate matter and preventing potential wound contamination, the suction step when performed with the cutting step, eliminates the need for a subsequent cleaning step and avoids increasing the amount of pyrogens in the dressing.

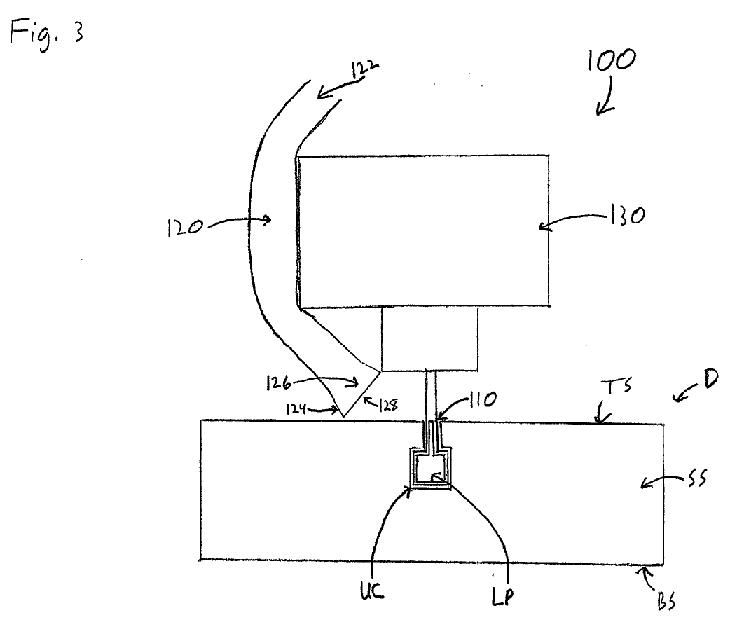

FIG. 3 shows a front view of the manufacturing system 100 cutting a square-shaped undercut channel UC in a dressing D. Dressing D has a top surface TS, bottom surface BS and a side surface SS. Cutting head 110 is inserted into the side surface SS of dressing D with the top surface TS of dressing D facing towards the underside of the base 130. The dressing D moves with respect to cutting head 110 to produce an undercut channel UC. In other embodiments, the cutting head 110 may be configured to move with respect to the dressing D.

A leftover portion LP of the dressing D remains in the undercut channel UC after the undercut channel UC is cut. This leftover portion LP can be removed from the undercut channel UC by pushing a first end of the leftover portion LP at a first end of the undercut channel UC. Pushing the first end of the leftover portion LP causes the leftover portion LP to slide through the undercut channel UC and out a second end of the undercut channel UC.

While FIG. 3 shows the suction tube 120 positioned to one side of the hot-wire cutting head 110 above the top surface TS of the dressing D, in other embodiments the suction tube 120 can have various positions in relation to the hot-wire cutting head 110. For, example, the suction tube 120 may have a suction manifold 126 positioned behind the hot-wire cutting tool 110 facing the side surface SS of the dressing D. This allows the suction manifold 126 to capture any small particulate debris that results from the cutting process from the side surface SS of the dressing D. Multiple suction tubes 120 may also be used. For example, suction tubes 120 may have suction manifolds 126 positioned above the top surface TS of the dressing D on two or more sides of the hot-wire cutting head 110. Additionally, a suction manifold 126 may be placed behind the hot-wire cutting tool 110 facing the side surface SS of the dressing D. In this configuration, the suction manifolds 126 can capture small particulate debris that results from the cutting process from the side of the undercut channel UC of the dressing D as well as from the top of the undercut channel UC of the dressing D. Further, the suction tubes may extend through the base 130 (not shown in FIGS. 2 and 3) or be attached to a side of the base 130 as shown in FIGS. 2 and 3.

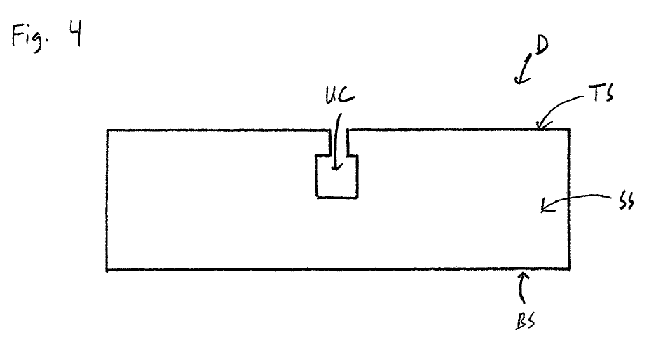

FIG. 4 shows a front view of the porous dressing D of FIG. 3 after the undercut channel UC has been cut and the leftover portion LP removed. A square shaped undercut UC, is shown on the top surface TS of porous dressing D. Although this embodiment is configured to make a square undercut, different shaped cutting heads configured to make different shaped undercuts may be used. For example, a circular shaped cutting head could be used to create a circular shaped undercut or a trapezoidal shaped cutting head could be used to create a trapezoidal shaped undercut.

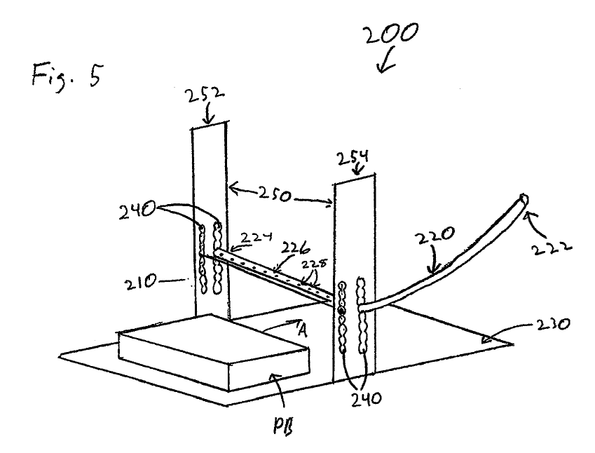

FIG. 5 shows a perspective view of a manufacturing system 200 for making a horizontal cut in a porous dressing, according to another embodiment. A saw table 230 includes a saw frame 250 having two posts 252, 254. A hot-wire cutting tool 210 has one end coupled to post 252 and another end coupled to post 254. Although a hot-wire cutting tool 210 is used, other suitable cutting devices such as wire saws or knives, may be used.

A suction tube 220 has a first end portion 222 and a second end portion 224. The first end portion of the suction tube 222 is configured to be connected to a suction source (not shown in FIG. 5). The suction source can have a high flow rate similar to that achieved with an industrial shop VAC. The second end portion of the suction tube 224 contains a suction manifold 226, which has one end coupled to post 252 and the other end coupled to post 254. The suction manifold 226 is in close proximity to the hot-wire cutting tool 210. The suction manifold 226 defines at least one opening 228 configured to receive small particulate debris that results from the cutting process when suction is applied to the suction manifold 226.

The height of the hot-wire cutting tool 210 and the suction manifold 226 can be adjusted in relation to the saw table 230. Posts 252, 254 have detents 240 that allow the height of the hot-wire cutting tool 210 and the height of the suction manifold 226 to be adjusted. The detents allow the user to snap the hot-wire cutting tool 210 and the suction manifold 226 in place at a desired height. This allows a user to modify the height of the horizontal cut within a porous block PB. In other embodiments, the height adjustment can be controlled by a motor. For example, the hot-wire cutting tool 210 and the suction manifold 226 can be attached to a moveable carriage which can be raised and lowered with, for example, an electric or hydraulic motor. Further, instead of the hot-wire cutting tool 210 and the suction manifold 226 having adjustable heights, in other embodiments the saw table 230 can have an adjustable height, allowing a user to modify the height of the horizontal cut within the porous block PB.

A porous block PB slides across the saw table 230 in direction A. When the porous block PB contacts the hot-wire cutting tool 210, a horizontal cut is made across the top of the porous block PB. As the horizontal cut is made, suction is applied to the first end portion of the suction tube 222. This produces suction at the suction manifold 226. Through the openings 228, the suction manifold 226 captures small particulate debris that results from the cutting process. Note that FIG. 5 shows the hot-wire cutting tool 210 and the suction manifold 226 at a height above the porous block PB; in use, the height of the cutting tool 210 and the suction manifold 226 would be reduced to make a horizontal cut in the porous block PB.

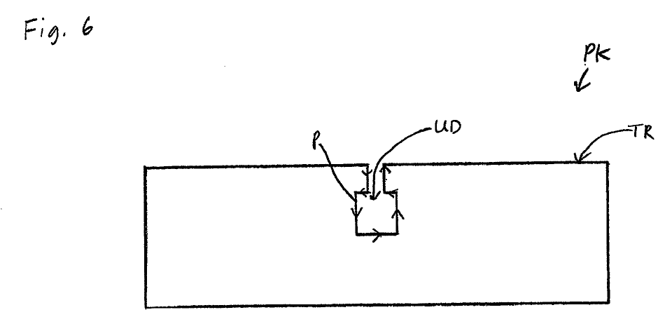

A system similar to manufacturing system 200 can also be used optionally to cut an undercut channel in a dressing. FIG. 6 shows a front view of a porous block PK with an undercut channel UD cut by a manufacturing system such as manufacturing system 200 where the suction manifold can be repositioned relative to the hot-wire cutting tool. To cut an undercut channel UD, the hot-wire cutting tool makes a cut in the top surface TR of the porous block PK. The perimeter of the desired shape of the undercut channel UD is traced with the hot-wire cutting tool. The arrows P depict an example of the path the hot-wire cutting tool can take to trace the perimeter and define the undercut channel UD. The portion of the porous dressing PK remaining in the undercut channel UD after the undercut channel UD is cut, may be removed in a manner similar to that used in FIG. 3. In these examples, the suction manifold can be repositioned to a location behind the hot-wire cutting tool as the hot-wire cutting tool changes directions within the porous block PK.

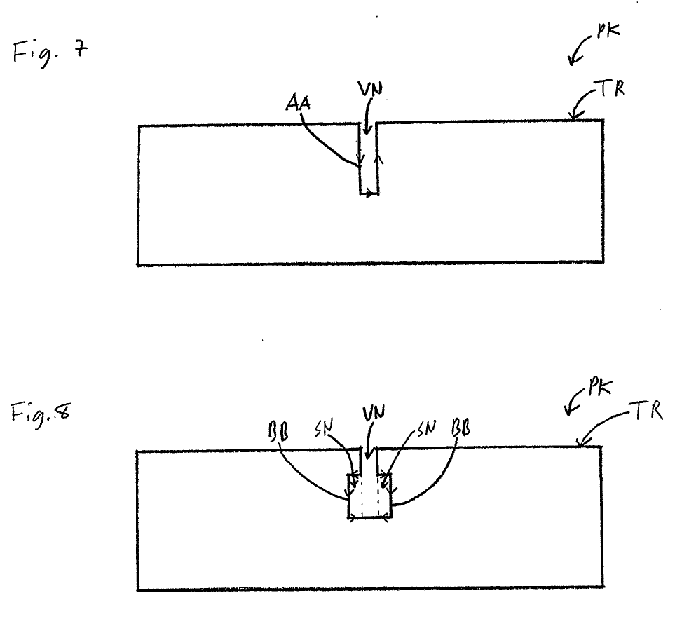

Alternative paths defined in manufacturing an undercut channel in a porous block PK are shown in FIGS. 7 and 8. FIGS. 7 and 8 show front views of a porous block PK at different stages of the cutting process. To define the undercut channel, a vertical notch VN is first cut in the top surface TR of the porous block PK. The arrows AA show the path the hot-wire cutting tool can take to cut the vertical notch VN. After the vertical notch VN is cut and the leftover portion of the porous block PK removed, two side notches SN can be cut. These side notches SN can be cut in the side walls of the vertical notch VN by the hot-wire cutting tool. The arrows BB show the path the hot-wire cutting tool can take to cut the side notches SN. The portion of the porous block PK remaining in the side notches SN after the side notches SN are cut, may be removed in a manner similar to that used in FIG. 3.

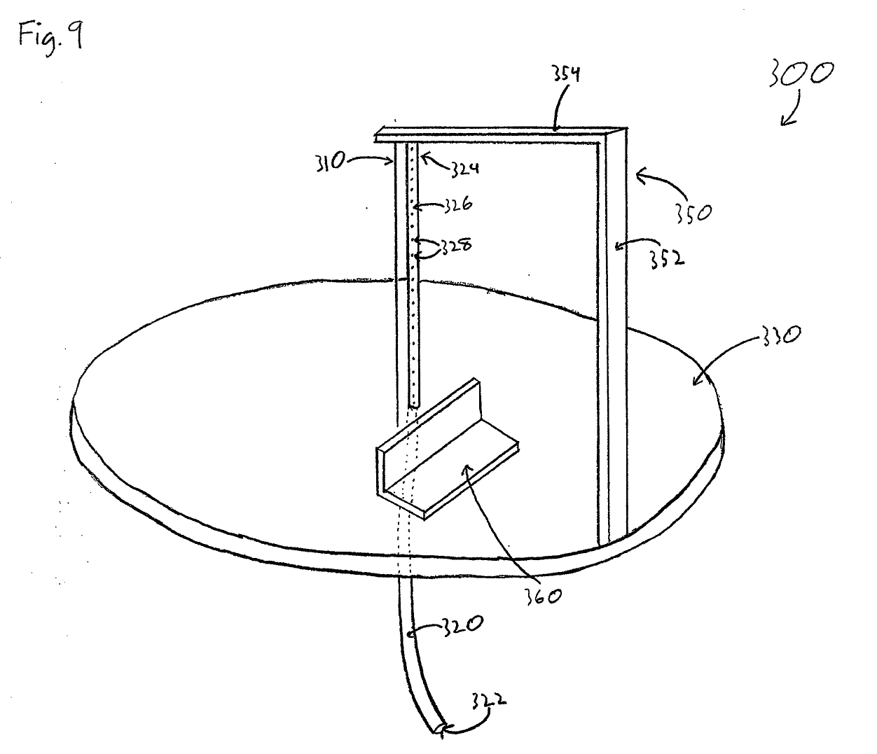

FIG. 9 shows a perspective view of a manufacturing system 300 for making vertical cuts in a porous dressing, according to an embodiment of the invention. A saw table 330 includes a saw frame 350 including a vertical portion 352 and a horizontal portion 354. The vertical portion 352 of the saw frame 350 extends upward and substantially perpendicular to the saw table 330. The horizontal portion 354 of the saw frame 350 extends above and substantially parallel to the saw table 330. A hot-wire cutting tool 310 extends between the horizontal portion 354 of the saw frame 350 and the saw table 330. Although a hot-wire cutting tool 310 is used, other suitable cutting devices such as wire saws or knives, may be used.

A suction tube 320 has a first end portion 322 and a second end portion 324. The first end portion 322 of the suction tube 320 is configured to be connected to a suction source (not shown in FIG. 9). The second end portion 324 of the suction tube 320 includes a suction manifold 326 that has one end coupled to the horizontal portion 354 of the saw frame 350 and the other end coupled to the saw table 330. The suction manifold 326 defines at least one opening 328 configured to receive small particulate debris that results from the cutting process when suction is applied to the suction manifold 326. The suction manifold 326 is in relatively close proximity to the hot-wire cutting tool 310. Although FIG. 9 shows the suction manifold 326 separated from the hot-wire cutting tool 310 at a given distance for illustrative purposes, it should be understand that the suction manifold 326 and the hot-wire cutting tool 310 can be positioned closer to each other than as shown in FIG. 9. In other embodiments, the suction manifold 326 can be monolithically formed with the hot-wire cutting tool 310.

The manufacturing system 300 also includes a fence 360 for guiding a porous block to be cut. As the porous block moves toward the hot-wire cutting tool 310 and the suction manifold 326, the porous block contacts the hot-wire cutting tool 310 first, making a vertical cut in the porous block. As the vertical cut is made, suction is applied to the first end portion of the suction tube 322. This produces suction at the suction manifold 326. Through the openings 328, the suction manifold 326 captures small particulate debris that results from the cutting process.

The fence 360 can be repositioned with respect to the hot-wire cutting tool 310 and the suction manifold 326 before and/or during the cutting process. For example, by moving (or repositioning) the fence 360 before the cutting process, the user can modify or select the depth and/or direction of the vertical cut within the porous block. Additionally, the user can change the effective distance between the suction manifold 326 and the porous block by moving the fence 360. For example, the user in one instance can move the fence in a direction aligned with the hot-wire cutting tool 310 and suction manifold 326; in another instance, the user can move the fence in a direction misaligned from the hot-wire cutting tool 310 and suction manifold 326. This allows the user to control the extent to which the suction is applied at the cut portion of the porous block during the cutting process.

As mentioned above, the fence 360 can be moved during the cutting process. This allows the user to change the direction (or alignment) of the vertical cut within one portion of the porous block with respect to another portion of the porous block during the cutting process. This also can allow the user to make vertical cuts within the porous block in non-linear directions (e.g., along a curved path). Alternatively, the fence 360 can be locked along a line or track (not shown) so that a vertical cut is made along a fixed direction within the porous block.

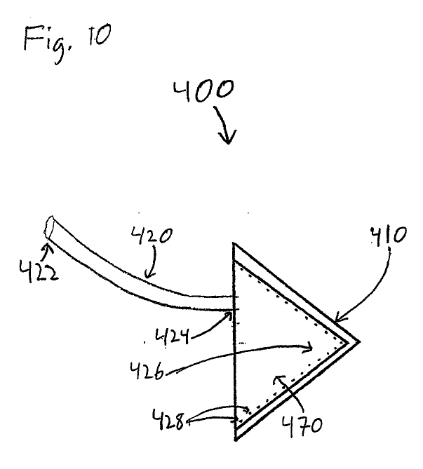

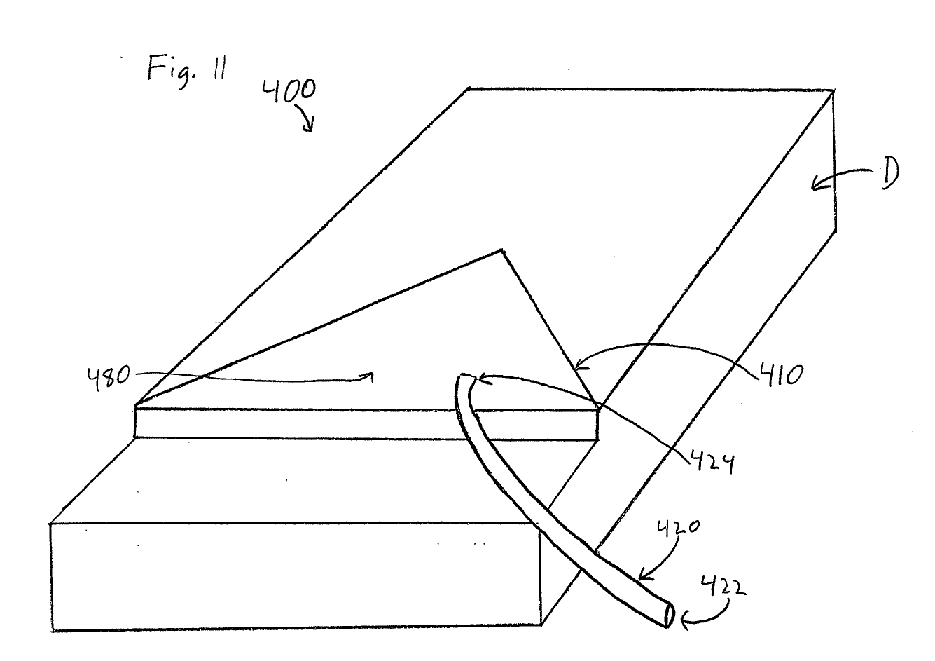

FIG. 10 and FIG. 11 show another embodiment of a manufacturing system. FIG. 10 shows a top view of the bottom surface of the manufacturing system 400 and FIG. 11 shows a perspective view of the top surface of the manufacturing system 400. The manufacturing system 400 has a wedge shape and includes a suction manifold 426 attached to the cutting head 410. The manufacturing system 400 has a top surface 480 and a bottom surface 470. The manufacturing system 400 has a cutting head 410 configured to cut a porous dressing. The cutting head 410 can be any device for cutting porous material, for example a hot-wire, wire saw or knife.

The manufacturing system 400 also includes a suction tube 420. The suction tube 420 has a first end portion 422 and a second end portion 424. The first end portion 422 of the suction tube 420 is configured to be connected to a suction source (not shown in FIG. 10 or FIG. 11). The manufacturing system 400 also includes a suction manifold 426, which is attached to the second end portion 424 of the suction tube 420. The suction manifold defines openings 428 in the bottom surface 470 of the manufacturing system 400.

As the cutting head 410 moves across the porous dressing D, suction is applied to the first end portion 422 of the suction tube 420. This produces suction at the suction manifold 426. Through the openings 428, the suction manifold 426 captures small particulate debris that results from the cutting process. While the embodiment shown is shaped like a wedge, the manufacturing system 400 could be any shape that would provide a desirable cut.

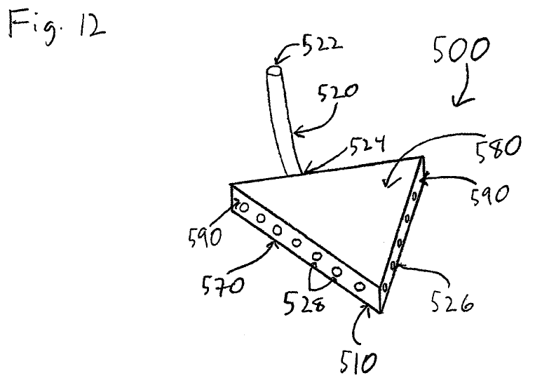

FIG. 12 is a perspective view another embodiment of a manufacturing system. The manufacturing system 500 has a wedge shape and includes a suction manifold 526 attached to the cutting head 510. The manufacturing system 500 has a top surface 580, a bottom surface 570 and side surfaces 590. The manufacturing system 500 has a cutting head 510 configured to cut a porous dressing. The cutting head 510 can be any device for cutting porous material, for example a hot-wire, wire saw or knife.

The manufacturing system 500 also includes a suction tube 520. The suction tube 520 has a first end portion 522 and a second end portion 524. The first end portion 522 of the suction tube 520 is configured to be connected to a suction source (not shown in FIG. 12). The manufacturing system 500 also includes a suction manifold 526 which is attached to the second end portion 524 of the suction tube 520. The suction manifold defines openings 528 in the side surfaces 590 of the manufacturing system 500. Manufacturing system 500 operates similar to the manufacturing system in FIG. 10 and FIG. 11.

In another embodiment, the embodiments shown in FIG. 10 and FIG. 12 can be combined and openings can be defined on the bottom surface and side surfaces of the manufacturing system. Further, in another embodiment, openings may be defined on the top surface as well as the bottom surface and side surfaces of the manufacturing system.

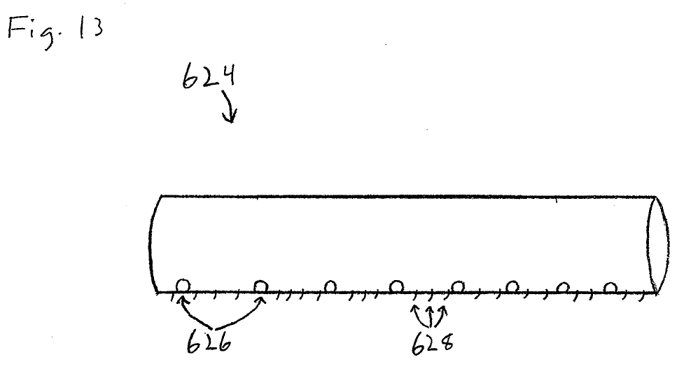

FIG. 13 shows a front view of a suction manifold, according to another embodiment. Suction manifold 624 has openings 626 configured to capture small particulate debris that results from the cutting process. Additionally, suction manifold 624 has bristles 628. The bristles 628 are configured to agitate a freshly cut porous dressing to loosen any particulate debris that may be disposed or stuck in the pores of the dressing. While bristles are shown as part of a circular manifold 624, bristles can be attached to any shape of manifold, such as the manifold 426 shown in FIG. 10.

While various embodiments have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified. Additionally, certain of the steps may be performed concurrently in a parallel process when possible, as well as performed sequentially as described above. The embodiments have been particularly shown and described, but it will be understood that various changes in form and details may be made.

For example, although various embodiments have been described as having particular features and/or combinations of components, other embodiments are possible having any combination or sub-combination of any features and/or components from any of embodiments as described herein. For example, the cutting heads used in the embodiments may be any device capable of cutting porous material, for example hot-wires, wire saws or knives. In addition, other embodiments may have a suction manifold that is attached to the cutting head as it is in FIG. 9 and FIG. 10. Further, any of the embodiments may have a stationary cutting head where the user moves the porous dressing to be cut or a movable cutting head where the porous dressing is held stationary while being cut.

What is claimed is:

1. An apparatus, comprising:
a cutting tool configured to cut a wound dressing; and
a tube having a distal end portion and a proximal end portion, the proximal end portion of the tube operatively coupled to a suction source, the distal end portion of the tube configured to be positioned relative to the cutting tool such that particulate debris is received in the distal end portion of the tube when the cutting tool cuts the wound dressing and the suction source is operating.
